(19) United States
(12) Patent Application Publication
(10) Pub. No.: US 2008/0163970 A1
(43) Pub. Date: Jul. 10, 2008

(54) PNEUMATIC TIRE AND A TIRE MOLD FOR MOLDING A TIRE

(75) Inventor: Masaaki Ohara, Osaka-shi (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka-fu (JP)

(21) Appl. No.: 11/970,800

(22) Filed: Jan. 8, 2008

(30) Foreign Application Priority Data
Jan. 9, 2007 (JP) 2007-001383
Jan. 15, 2007 (JP) 2007-006275

(51) Int. Cl. B60C 13/02; B29C 33/00

(52) U.S. Cl. 152/523; 249/187.1

(57) ABSTRACT

The pneumatic tire is provided with a plurality of main grooves 1, a rib 2 formed at least on the shoulder portion of the tread, and a fine groove 3 that extends in the tire circumferential direction on the inner side of the tire width direction than the grounding end E, in which the fine groove 3 is provided with narrowed portions 11 and wide portions 12 alternately at the tread opening portion, and the groove bottom 5 of the fine groove 3 is cross-sectional arc shaped and the sidewall 3a of the fine groove 3 on the inner side in the tire width direction is substantially vertical to the tread surface and is joined to the groove bottom 5, and the sidewall 11a of the narrowed portions on the outer side in the tire width direction is joined to the groove bottom 5 so that the groove width becomes larger as the sidewall 11 a goes toward the groove bottom 5.

### CROSS-REFERENCE TO RELATED APPLICATION

The description of this application claims benefit of priority based on Japanese Patent Application No. 2007-001383 and Japanese Patent Application No. 2007-006275, the entire same contents of which are incorporated by reference herein.

### BACKGROUND OF THE INVENTION

1. Field of the Invention

The present invention relates to a pneumatic tire, and in more detail, the present invention relates to the pneumatic tire provided with thin ribs in the vicinity of a grounding end and with inhibited uneven wear at a shoulder portion and a tire mold for molding the pneumatic tire.

2. Description of the Prior Art

In a pneumatic tire, since grounding pressure at a shoulder portion of a tread gets higher, there used to arise a problem of uneven wear in which the wear amount at the shoulder portion is greater than at the other portions. In order to inhibit such uneven wear, as shown in FIG. 1, a fine groove 3 is formed that extends in the tire circumferential direction from a grounding end E to the inner side in the tire width direction, and a thin rib 4 sandwiched by the fine groove 3 and the grounding end E is provided. As a result, rigidity at the shoulder portion of the tread T is degraded by the thin rib 4, and the grounding pressure at the shoulder portion gets lower, thereby capable of inhibiting the uneven wear. As one example of such a pneumatic tire, the one disclosed in Patent Document 1 is known (Patent document 1: Unexamined Japanese Laid-Open Patent Publication No. 11-151910).

In the above mentioned pneumatic tire, the thin rib 4 is liable to deformation caused by force from a road surface. When the tire roles on a road with a step G as shown in FIG. 2, the fine groove 3 is opened widely by the step, and when the tire groove 3 is deformed extremely, cracks are generated at the groove bottom of the fine groove 3, which sometimes degrades durability of the tire. It can also be considered to narrow the width of the thin rib 4 in order to inhibit generation of cracks. However, to do so might make the inhibition effect of the uneven wear unsatisfactory, which sometimes leads the thin rib 4 to break. And when the thin rib 4 disappears, the inhibition effect of the uneven wear disappears, too.

As a measure for preventing cracks generated at the groove bottom of the fine groove 3, it can be considered to let the whole groove bottom have curvature and enlarge the radius of the curvature at the groove bottom, thereby attempting to prevent cracks. However, when the groove width of the fine groove 3 on the tread surface is enlarged, the thin rib 4 is likely to be hooked on the road surface due to the external force from the road surface and therefore, the thin rib 4 is likely to be deformed. Thus, there is a limit for enlarging the radius of the curvature by enlarging the groove width of the fine groove 3, and the effect for preventing cracks is not satisfactory.

When the groove width of the fine groove is narrowed as it goes toward the tread surface, in a molding portion of the fine groove (for example, a blade) that molds the fine groove, the groove width is narrow in the vicinity of the tread molding surface that molds the tread surface, and the width becomes larger as it goes toward the end. As a result, the strength at the joining portion of the molding portion and the tread molding surface is degraded and when a mold is opened, there is a concern of damaging molding portion of the fine groove, leaving the problem of durability of the mold.

Therefore, the object of the present invention is to provide a pneumatic tire that effectively inhibits the uneven wear and has improved durability at the shoulder portion, and to provide a tire mold with durability for molding such a pneumatic tire.

### SUMMARY OF THE INVENTION

The pneumatic tire of the present invention has characteristics in that it relates to the pneumatic tire provided with a plurality of main grooves formed that extend in the tire circumferential direction on a tread, with ribs formed at least on a shoulder portion of the tread, the fine grooves formed that extend in the tire circumferential direction more of the inner side in the tire width direction than the grounding end, wherein the fine grooves are provided with narrowed portions and wide portions alternately in the circumferential direction at a tread opening portion, the groove bottoms of the fine grooves are cross-sectional arc shaped, the sidewalls of the fine grooves on the inner side in the tire width direction are substantially vertical to the tread surface and are joined to the groove bottoms, and the sidewalls of the narrowed portions on the outer side in the tire width direction are joined so that the groove width becomes larger as the sidewalls go toward the groove bottoms.

The pneumatic tire of the present invention has characteristics in that it relates to the pneumatic tire provided with a plurality of main grooves formed that extend in the tire circumferential direction on a tread, with ribs formed at least on a shoulder portion of the tread, the fine grooves formed that extend in the tire circumferential direction more of the inner side in the tire width direction than the grounding end, wherein the fine grooves are provided with narrowed portions and wide portions alternately in the circumferential direction at a tread opening portion, the groove bottoms of the fine grooves are cross-sectional arc shaped, the sidewalls of the fine grooves on the outer side in the tire width direction are substantially vertical to the tread surface and are joined to the groove bottoms, and the sidewalls of the narrowed portions on the inner side in the tire width direction are joined so that the groove width becomes larger as the sidewalls go toward the groove bottoms.

By forming the fine grooves that extend in the tire circumferential direction more of the inner side than the grounding end, since the rigidity at the shoulder portion is degraded and the grounding pressure is lowered, uneven wear is inhibited. By making the groove bottoms of the fine grooves cross-sectional arc shaped, the generation of the cracks at the groove bottoms can be inhibited. Further, since the sidewalls of the narrowed portions in the outer (or inner) side in the tire width direction are joined to the groove bottoms so that the groove width becomes wider as the sidewalls go toward the groove bottoms, the rigidity in the vicinity of the narrowed portion of the thin ribs, the rigidity of the thin ribs as a whole is degraded, the rigidity at the shoulder portion of the tread is degraded, and the grounding pressure of the shoulder portion is lowered, thereby inhibiting the uneven wear at the shoulder portion. For information, “the groove width becomes larger as the sidewalls go toward the groove bottoms” not only includes the meaning that the groove width becomes larger as the sidewalls of the narrowed portions are inclined but also includes the meaning that a constant width is maintained until the sidewalls go from the tread surfaces to the groove bottoms, and then the groove width becomes larger.

Since the fine grooves are provided with the wide portions, as mentioned later, the fine groove molding portions of the tire mold molding the fine grooves are reinforced and the loss of the fine groove molding portions are inhibited and therefore, the durability of the tire mold for molding tires is improved. For information, it is preferable that the width of the narrowed portions of the fine grooves at the tread opening portions are 0.1 to 0.5 times as the maximum width of the groove bottoms of the fine grooves, and that the maximum width of the wide portions of the fine grooves at the tread opening portions are 0.5 to 1.4 times as the maximum width of the groove bottoms of the fine grooves.

The tire mold for molding tires of the present invention has characteristics in that it relates to the tire mold for molding tires provided at least with main groove molding portions that protrude from the tread molding surface of the mold and that mold the main grooves extending in the tire circumferential direction of a tread and with fine groove molding portions that protrude from the tread molding surface and that mold the fine grooves extending in the tire circumferential direction on the rib formed by the main groove molding portions, wherein the fine groove molding portions are provided with narrowed portions and wide portions alternately in the circumferential direction at the joining portion of the tread molding surface, the tip portion of the fine groove molding portions is cross-sectional arc shaped, the sidewalls of the fine groove molding portions on the inner side in the tire width direction are substantially vertical to the tread molding surface and are joined to the tip portion, and the sidewalls of the narrowed portions on the outer side in the tire width direction are joined so that the width becomes larger as the sidewalls go toward the end portion.

The tire mold for molding tires of the present invention has characteristics in that it relates to the tire mold for molding tires provided at least with main groove molding portions that protrude from the tread molding surface of the mold and that mold the main grooves that extend in the tire circumferential direction of a tread and with fine groove molding portions that protrude from the tread molding surface and that mold the fine grooves that extend in the tire circumferential direction on the rib formed by the main groove molding portions, wherein the fine groove molding portions are provided with narrowed portions and wide portions alternately in the circumferential direction at the joining portion of the tread molding surface, the tip portion of the fine groove molding portions is cross-sectional arc shaped, the sidewalls of the fine groove molding portions on the outer side in the tire width direction are substantially vertical to the tread molding surface and are joined to the tip portion, and the sidewalls of the narrowed portions on the inner side in the tire width direction are joined so that the groove width becomes larger as the sidewalls go toward the tip portion.

Since the fine groove molding portion of the tire mold is provided with the narrowed portions and the wide portions, the fine groove molding portions of the tire mold at the joining portion of the tread molding surface are reinforced and the loss of the fine groove molding portion is inhibited. As a result, the durability of the tire mold for molding tires is improved. For information, “the width becomes larger as the sidewalls go toward the tip portion” not only includes the meaning that the width becomes larger as the sidewalls of the narrowed portions are inclined but also includes the meaning that a constant width is maintained until the sidewalls go from the tread surfaces to the tip portion, and then the width becomes larger. In addition, it is preferable that the width of the narrowed portions of the fine groove molding portion at the joining portion with the tread molding surface is 0.1 to 0.5 times as the maximum width of the tip portion of the fine groove molding portion, and that the maximum width of the wide portions at the joining portion with the tread molding surface is 0.5 to 1.4 times as the maximum width of the tip portion of the fine groove molding portion.

### BRIEF DESCRIPTION OF THE DRAWINGS

FIG. 1 is an oblique perspective view showing the tread shoulder portion in the conventional pneumatic tire.

FIG. 2 is across-sectional view showing the grounding state on a stepped road surface in the conventional pneumatic tire.

FIG. 3 is an oblique perspective view showing the tread shoulder portion in the pneumatic tire of the present invention.

FIG. 4 is a view showing the detail of the fine groove in FIG. 3.

FIG. 5 is an oblique perspective view showing the tread shoulder portion in the pneumatic tire of the present invention.

FIG. 6 is a view showing the detail of the fine groove in FIG. 5.

FIG. 7 is an oblique perspective view showing the tread shoulder portion in the pneumatic tire of the present invention.

FIG. 8 is a view showing the detail of the fine groove in FIG. 7.

FIG. 9 is an oblique perspective view showing the tread shoulder portion in the pneumatic tire of the present invention.

FIG. 10 is a view showing the detail of the fine groove in FIG. 9.

FIG. 11 is an oblique perspective view showing the tread shoulder portion in the pneumatic tire of the present invention.

FIG. 12 is a view showing the detail of the fine groove in FIG. 11.

FIG. 13 is an oblique perspective view showing the tread shoulder portion in the pneumatic tire of the present invention.

FIG. 14 is a view showing the detail of the fine groove in FIG. 13.

FIG. 15 is an oblique perspective view showing the tread shoulder portion in the pneumatic tire of the present invention.

FIG. 16 is a view showing the detail of the fine groove in FIG. 15.

FIG. 17 is an oblique perspective view showing the tread shoulder portion in the pneumatic tire of the present invention.

FIG. 18 is a view showing the detail of the fine groove in FIG. 17.

FIG. 19 is an oblique perspective view showing a part of the tire mold for molding the tire of the present invention.

FIG. 20 is an oblique perspective view showing a part of the tire mold for molding the tire of the present invention.

FIG. 21 is an oblique perspective view showing a part of the tire mold for molding the tire of the present invention.

FIG. 22 is an oblique perspective view showing a part of the tire mold for molding the tire of the present invention.

FIG. 23 is an oblique perspective view showing a part of the tire mold for molding the tire of the present invention.

FIG. 24 is an oblique perspective view showing a part of the tire mold for molding the tire of the present invention.

FIG. 25 is an oblique perspective view showing a part of the tire mold for molding the tire of the present invention.

FIG. 26 is an oblique perspective view showing a part of the tire mold for molding the tire of the present invention.

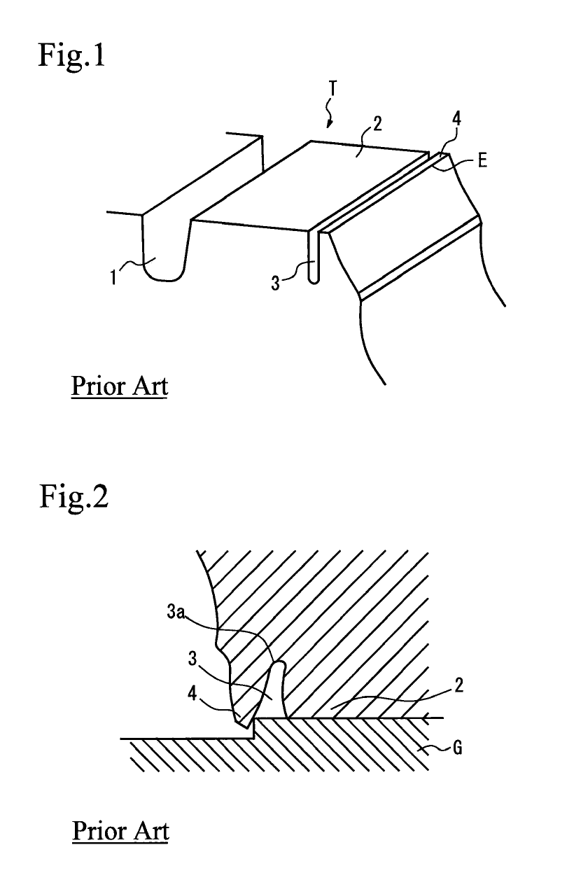

### DESCRIPTION OF THE PREFERRED EMBODIMENTS

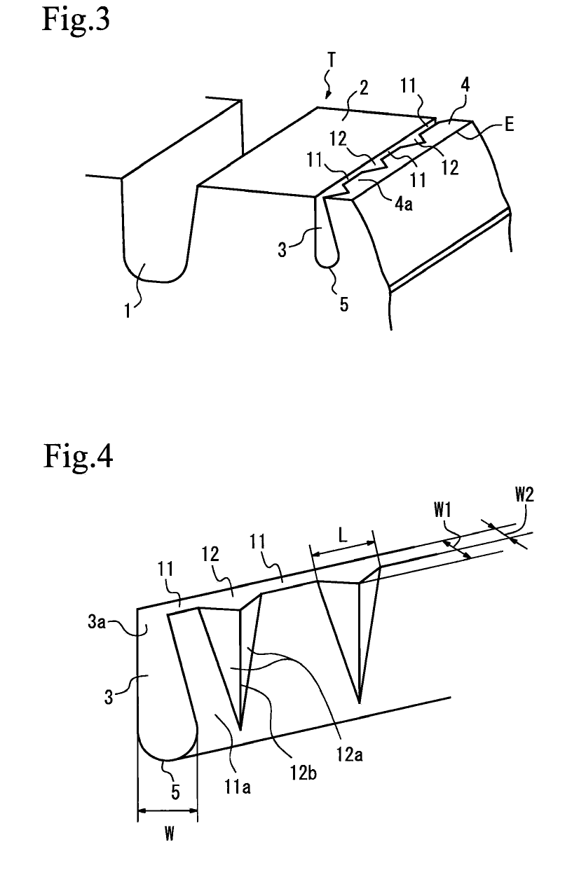

Hereinafter, explanation on embodiments for carrying out the pneumatic tire of the present invention is made using drawings. FIG. 3 is an oblique perspective view showing the shoulder portion of a tire tread. FIG. 4 shows the fine groove of the FIG. 3. A main groove 1 extending in the tire circumferential direction R is formed on a tread T. A rib 2 is formed on a shoulder portion by the illustrated outermost main groove 1 in the width direction and the grounding end E. Further, a fine groove 3 is formed in the circumferential direction from the grounding end E to the inner side in the tire width direction, and a thin rib 4 is formed. For information, members such as belt layers, belt reinforcement layers, and the like are omitted in FIG. 3. In addition, ribs may be arranged in an inner region of the illustrated outermost main groove 1 in the width direction, and blocks may be arranged partially or entirely.

The fine groove 3 is provided with narrowed portions 11 and wide portions 12 alternately in the circumferential direction. The narrowed portions 11 are the portions in which the width is constant and narrow on the tread surface T, and the wide portions 12 are the portions other than the narrowed portions 11. Since the groove bottom 5 is arc shaped, even when the thin rib 4 is deformed by the force from the road surface, generation of cracks at the groove bottom 5 can be inhibited. In addition, although the sidewall 11a of the narrowed portion 11 is joined to the groove bottom 5, from the viewpoint of preventing the generation of cracks, it is preferable that the tangent plane of the arc of the groove bottom 5 at the joining portion is joined to be identical to the sidewall 11a (tangential to the sidewall 11a).

The sidewall 3a on the inner side in the tire width direction of the fine groove 3 is substantially vertical to the tread T, however, since the sidewall 11a of the narrowed portion 11 on the outer side in the tire width direction is inclined so that the groove width becomes gradually larger as it goes toward the groove bottom, the rigidity of the vicinity 4a of the wide portion 11 of the thin rib 4 is degraded. As a result, the rigidity at the shoulder portion of the tread T is degraded by the thin rib 4, lowering the grounding pressure at the shoulder portion, which inhibits the uneven wear at the shoulder portion. For information, in the present application, substantially vertical means the range of 85 to 95 degrees.

The sidewall 12a of the wide portion 12 on the outer side in the tire width direction is V-shaped at the tread opening portion and at least one part thereof (edge 12b in the drawings) is vertical to the surface of the tread T and is joined to the groove bottom 5. In view of the fine groove molding portion of the tire mold that molds the fine grooves, since the fine groove molding portion is reinforced by the portion that molds the wide portion 12 and the loss of the fine groove molding portion is inhibited, the durability of the tire mold for molding the pneumatic tire of the present invention is improved. For information, the wide portion 12 may be formed on the outer side in the tire width direction and the edge 12b may be inclined either on the outer side in the tire width direction or on the inner side in the tire width direction. Further, from the view point of inhibiting the generation of cracks, it is preferable that the edge 12b and the groove bottom 5 are joined so that the edge 12b is on the tangent plane of the arc of the groove bottom 5.

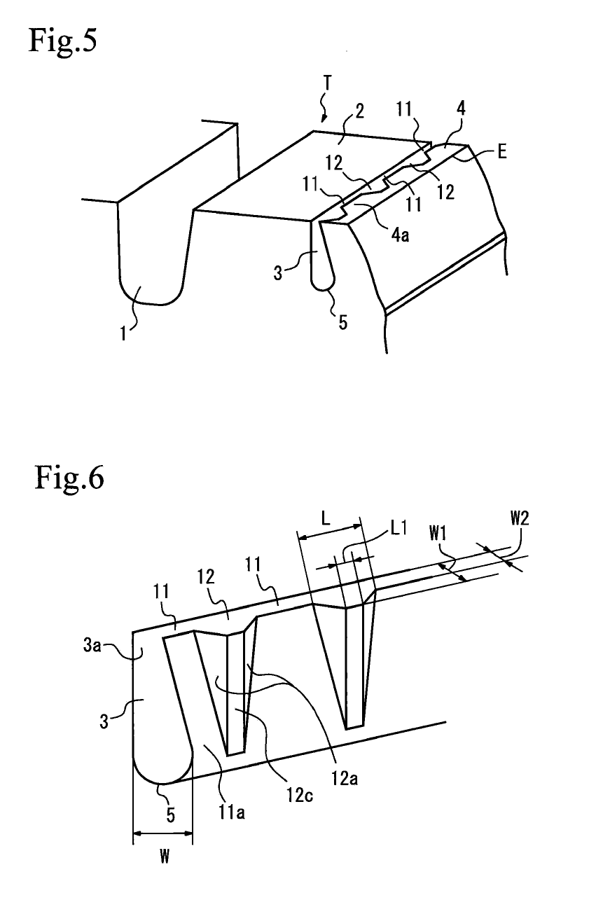

In another embodiment of the present invention as shown in FIGS. 5 and 6, the top portion of the V-shape of the wide portion 12 at the tread opening portion composes sidewall 12c that has a constant width L1, and the sidewall 12a connects the sidewall 12c and the sidewall 11a of the narrowed portion 11. The sidewall 12c may be inclined either on the outer side in the tire width direction or on the inner side in the tire width direction. Further, from the viewpoint of preventing cracks, it is preferable that the tangent plane of the arc of the groove bottom 5 at the joining portion is joined tangentially to the sidewall 12c so that the tangent plane is identical to the sidewall 12c.

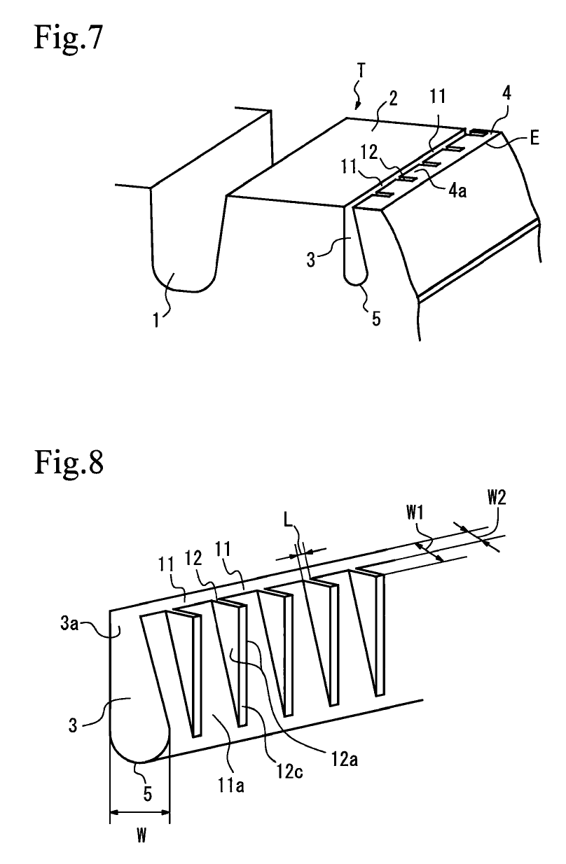

In another embodiment of the present invention as shown in FIGS. 7 and 8, the wide portion 12 has a constant width at the tread opening portion and composes the sidewall 12c, and the sidewall 12a connects the sidewall 12c and sidewall 11a of the narrowed portion 11. The sidewall 12a is vertical to the traveling direction of the fine groove 3. In this case, the sidewall 12c may also be inclined either on the outer side in the tire width direction or on the inner side in the tire width direction. Further, from the viewpoint of preventing cracks, it is preferable that the tangent plane of the arc of the groove bottom 5 at the joining portion is joined tangentially to the sidewall 12c so that the tangent plane is identical to the sidewall 12c.

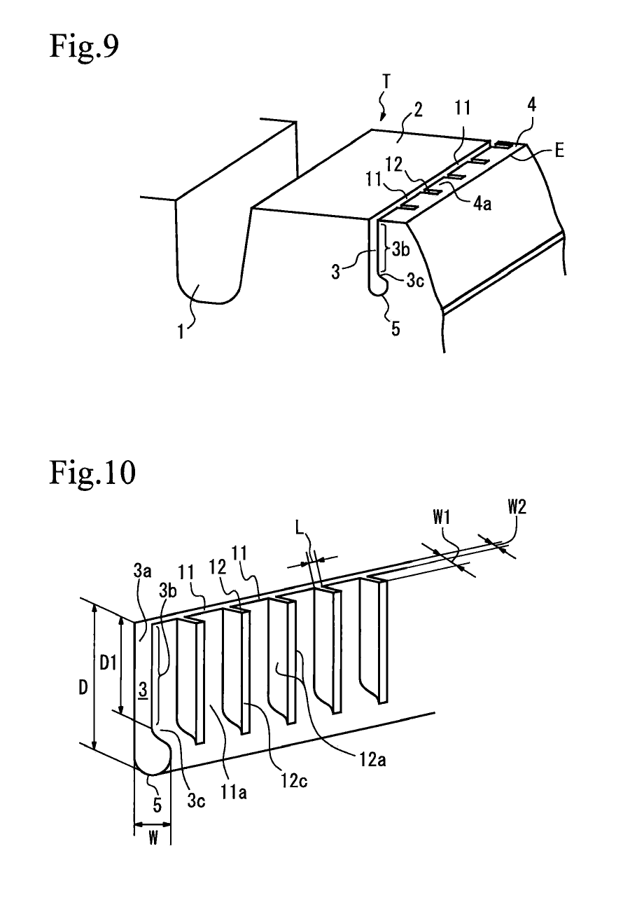

Another embodiment of the present invention as shown in FIGS. 9 and 10 is different from that as shown in FIGS. 7 and 8 in that the groove width of the narrowed portion 11 of the fine groove 3 has a constant width at the constant width portion 3b from the surface of the tread T halfway toward the groove bottom 5, and then the groove width of the narrowed portion 11 becomes larger. From the view point of preventing cracks, the constant width portion 3b and the groove bottom 5 are smoothly joined. For example, the constant width portion 3b and the groove bottom 5 may be joined with the curved surface 3c that is convex to the inner side of the groove. Also, the inclined surface may be provided from the end portion of the groove bottom side of the constant width portion 3b to let it contact with the groove bottom as shown in FIGS. 7 and 8, and in this case, when D1 is set to be zero, the embodiment becomes identical with that shown in FIGS. 7 and 8. It is preferable that D1 that is the depth of the constant width portion 3b of the narrowed portion is not greater than 70% of D that is the depth of the fine groove 3. When D1 exceeds 70% of D, since the groove width dramatically becomes large, cracks are likely to be generated. In this case, the sidewall 12c may also be inclined either on the outer side in the tire width direction or on the inner side in the tire width direction. Further, from the viewpoint of preventing cracks, it is preferable that the contact surface of the arc of the groove bottom 5 at the joining portion is joined tangentially to the sidewall 12c so that the tangent plane is identical to the sidewall 12c.

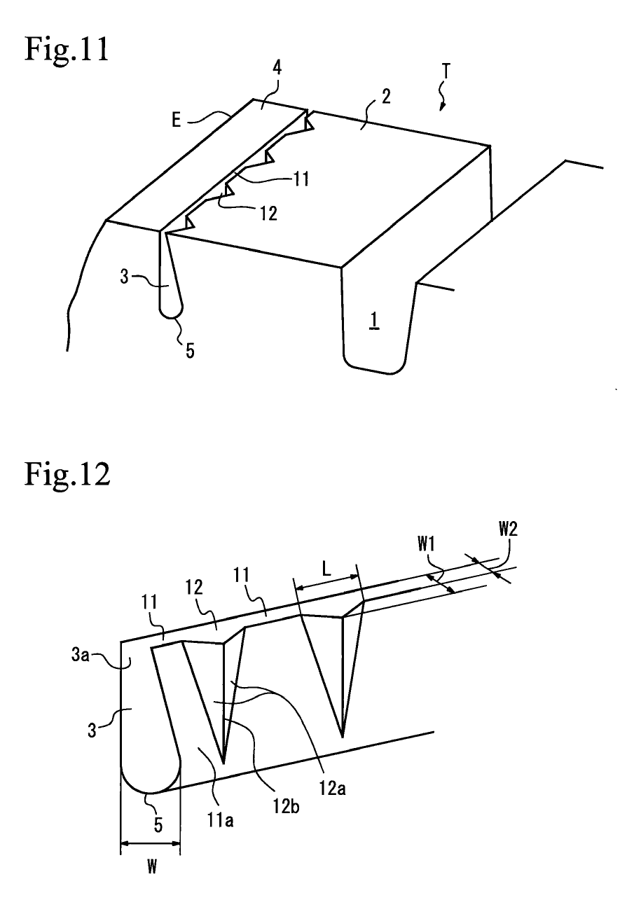

The embodiment may also include that the sidewall 3a that is substantially vertical to the fine groove 3 is provided on the inner side in the tire width direction. FIG. 11 is an oblique perspective view showing the shoulder portion of a tire tread. FIG. 12 shows the fine groove of the FIG. 11. A main groove 1 extending in the tire circumferential direction R is formed on a tread T. A rib 2 is formed on a shoulder portion by the outermost main groove 1 in the width direction as illustrated and the grounding end E. Further, a fine groove 3 is formed extending in the circumferential direction from the grounding end E to the inner side in the tire width direction, and a thin rib 4 is formed. For information, members such as belt layers, belt reinforcement layers, and the like are omitted in FIG. 3. In addition, ribs may be arranged in an inner region of the illustrated outermost main groove 1 in the width direction, and blocks may be arranged partially or entirely.

The fine groove 3 is provided with narrowed portions 11 and wide portions 12 alternately in the circumferential direction. The narrowed portion 11 is the portion in which the width is constant and narrow on the tread surface T, and the wide portion 12 is the portion other than the narrowed portion 11. Since the groove bottom 5 is arc shaped, even when the thin rib 4 is deformed by the force from the road surface, generation of cracks at the groove bottom 5 can be inhibited. In addition, although the sidewall 11a of the narrowed portion 11 is connected to the groove bottom 5, from the view point of preventing cracks, it is preferable that the tangent plane of the arc of the groove bottom 5 of the joining portion is connected to be identical to the sidewall 11a (tangential to the sidewall 11a).

The sidewall 3a on the outer side in the tire width direction of the fine groove 3 is substantially vertical to the tread T. On the other hand, since the sidewall 11a of the narrowed portion 11 on the inner side in the tire width direction is inclined so that the groove width becomes gradually wider as it goes toward the groove bottom, the rigidity of the vicinity 4a of the wide portion 11 of the thin rib 4 is degraded. As a result, the rigidity at the shoulder portion of the tread T is degraded by the thin rib 4, lowering the grounding pressure at the shoulder portion, which inhibits the uneven wear of the shoulder portion.

The sidewall 12a of the wide portion 12 on the inner side in the tire width direction is V-shaped at the tread opening portion and at least one part thereof (edge 12b in the drawings) is vertical to the surface of the tread T and is joined to the groove bottom 5. In view of the fine groove molding portion of the tire mold that molds the fine grooves, since the fine groove molding portion is reinforced by the portion that molds the wide portion 12 and the loss of the fine groove molding portion is inhibited, the durability of the tire mold for molding the pneumatic tire of the present invention is improved. For information, the wide portion 12 may be formed on the outer side in the tire width direction and the edge 12b may be inclined either on the outer side in the tire width direction or on the inner side in the tire width direction. Further, from the view point of inhibiting cracks, it is preferable that the edge 12b and the groove bottom 5 are joined so that the edge 12b is on the tangent plane of the arc of the groove bottom 5.

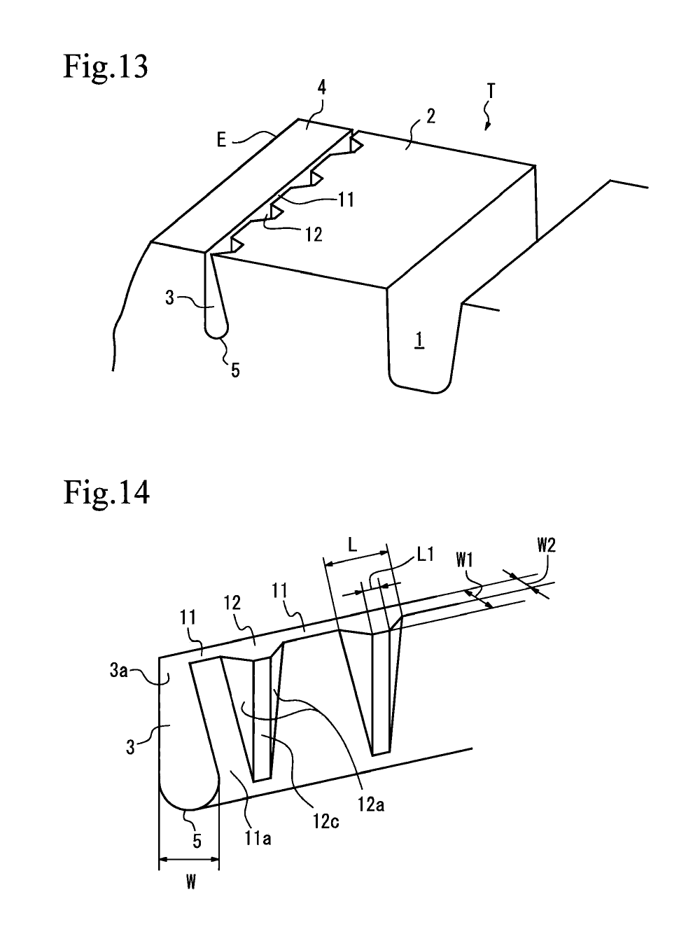

In another embodiment of the present invention as shown in FIGS. 13 and 14, the top portion of the V-shape of the wide portion 12 at the tread opening portion composes sidewall 12c that has a constant width L1, and the sidewall 12a connects the sidewall 12c and sidewall 11a of the narrowed portion 11. The sidewall 12c may be inclined either on the outer side in the tire width direction or on the inner side in the tire width direction. Further, from the viewpoint of preventing cracks, it is preferable that the tangent plane of the arc of the groove bottom 5 at the joining portion is joined tangentially to the sidewall 12c so that the tangent plane is identical to the sidewall 12c.

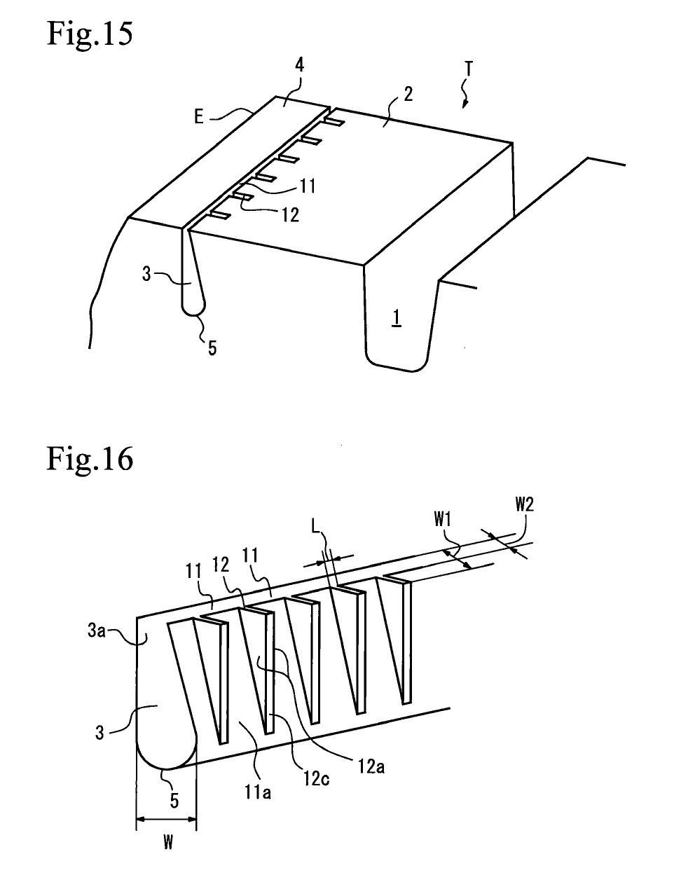

In another embodiment of the present invention as shown in FIGS. 15 and 16, the wide portion 12 has a constant width at the tread opening portion and composes the sidewall 12c, and the sidewall 12a connects the sidewall 12c and sidewall 11a of the narrowed portion 11. The sidewall 12a is vertical to the traveling direction of the fine groove 3. In this case, the sidewall 12c may also be inclined either on the outer side in the tire width direction or on the inner side in the tire width direction. Further, from the viewpoint of preventing cracks, it is preferable that the tangent plane of the arc of the groove bottom 5 at the joining portion is joined tangentially to the sidewall 12c so that the tangent plane is identical to the sidewall 12c.

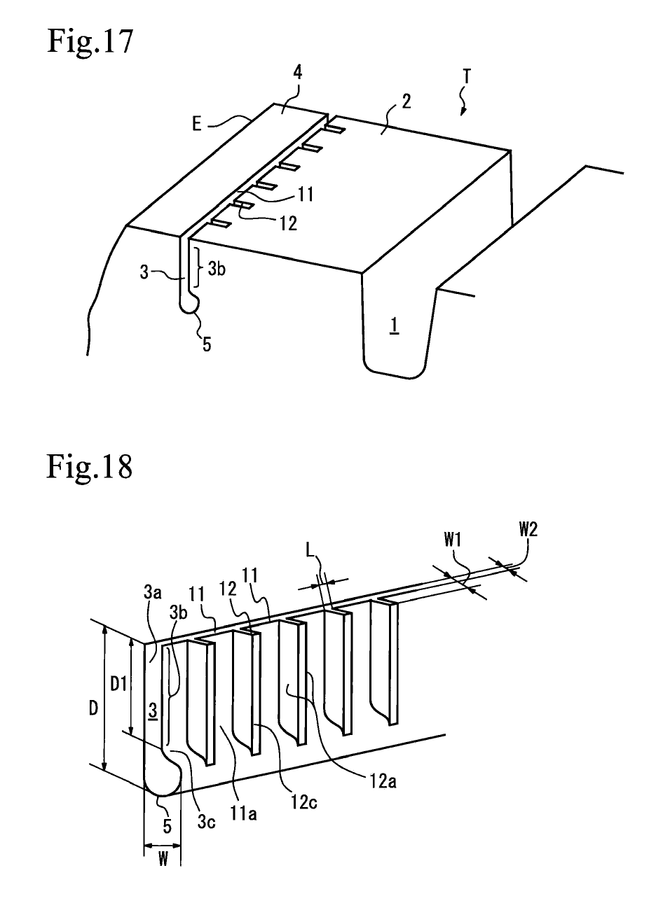

Another embodiment of the present invention as shown in FIGS. 17 and 18 is different from that as shown in FIGS. 15 and 16 in that the groove width of the narrowed portion 11 of the fine groove 3 has a constant width at the constant width portion 3b from the surface of the tread T halfway toward the groove bottom 5, and then the groove width of the narrowed portion 11 becomes larger. From the view point of preventing cracks, the constant width portion 3b and the groove bottom 5 are smoothly joined. For example, the constant width portion 3b and the groove bottom 5 may be joined with the curved surface 3c that is convex to the inner side of the groove. Also, the inclined surface may be provided from the end portion of the groove bottom side of the constant width portion 3b to let it contact with the groove bottom as shown in FIGS. 15 and 16, and in this case, when D1 is set to be zero, the embodiment becomes identical with that shown in FIGS. 15 and 16. It is preferable that D1 that is the depth of the constant width portion 3b of the narrowed portion is not greater than 70% of D that is the depth of the fine groove 3. When the depth D1 exceeds 70% of D, since the groove width dramatically becomes large, cracks are likely to be generated. In this case, the sidewall 12c may also be inclined either on the outer side in the tire width direction or on the inner side in the tire width direction. Further, from the viewpoint of preventing cracks, it is preferable that the tangent plane of the arc of the groove bottom 5 at the joining portion is joined tangentially to the sidewall 12c so that the tangent plane is identical to the sidewall 12c.

Further, in any embodiment as shown above, it is preferable that W2 that is the width of the narrowed portion 11 of the fine groove 3 at the tread opening portion is 0.1 to 0.5 times as W that is the maximum width of the groove bottom 5 of the fine groove 3 and that W1 that is the maximum width of the wide portion 12 at the tread opening portion is 0.5 to 1.4 times as W that is the maximum width of the groove bottom 5 of the fine groove 3. When W2 that is the width of the narrowed portion 11 exceeds 0.5 times as W that is the maximum width of the groove bottom 5, the thin ribs 4 are likely to be hooked on the road surface due to the external force from the road surface and therefore, cracks are more likely to be generated or the thin rib 4 is likely to be damaged. While on the other hand, when W2 that is the width of the narrowed portion 11 is less than 0.1 times as W that is the maximum width of the groove bottom 5, manufacturing the fine groove molding portion for molding the fine groove 3 becomes difficult. Further, subject to the force at the time of opening the mold after vulcanization molding, the narrow portion 11 sandwiched by the wide portions is deformed and arched, thereby degrading the durability of the fine groove molding portion. When W1 that is the maximum width of the wide portions 12 is less than 0.5 times as the maximum width of the groove bottom portion 5, the effect that the portion corresponding to the wide portion 12 of the fine groove molding portion reinforces the fine groove molding portion is hard to be obtained. On the other hand, when W1 that is the maximum width of the wide portions 12 exceeds 1.4 times as the maximum width of the groove bottom portion 5, a narrow portion is generated in the thin rib 4 by the wide portions 12 and chips or cracks may be generated thereby damaging the thin rib 4. Further, from the view point of effectively inhibiting uneven wear and reinforcing the fine groove molding portion, it is preferable that the difference between W1 that is the maximum width of wide portion 12 and W2 that is the width of the narrowed portion 11 (W1-W2) is not less than 0.2 times as W that is the maximum width of the groove bottom portion 5.

In addition, from the view point of preventing the generation of cracks by satisfactorily securing the radius of the curvature of the groove bottom portion 5, it is preferable that W that is the maximum width is not less than 3.0 mm. From the view point of securing the width of the thin rib 4, it is preferable that W that is the maximum width of the groove bottom portion 5 is not greater than 6.0 mm. As shown in the drawings, in the embodiments shown in FIGS. 3 to 10, it is preferable that the edge on the tread surface on the inner side in the tire width direction of the fine groove 3 is linear. In the embodiments shown in FIGS. 11 to 18, it is preferable that the edge on the tread surface on the outer side in the tire width direction of the fine groove 3 is linear. When there are cutouts and the like in the edge, the rigidity of the rib 2 at the shoulder portion changes in the circumferential direction. As a result, uneven wear may occur from the parts in which the rigidity of the rib 2 changes.

Further, from the viewpoint of reinforcing the fine groove molding portion of the mold, it is preferable that the number of the wide portion 12 is not less than 20 on the whole circumference of the fine groove 3, that the L that is the length of the wide portion 12 is 0.5 to 25.0 mm, and that the total sum of the length L is 10 to 30% of the circumferential length of the fine groove 3. When the length L is less than 10%, the reinforcement of the fine groove molding portion is not satisfactory, while on the other hand, when the length L exceeds 30%, the movement gets bigger by the force from the road surface of the thin rib 4, and the effect of inhibiting cracks gets unsatisfactory.

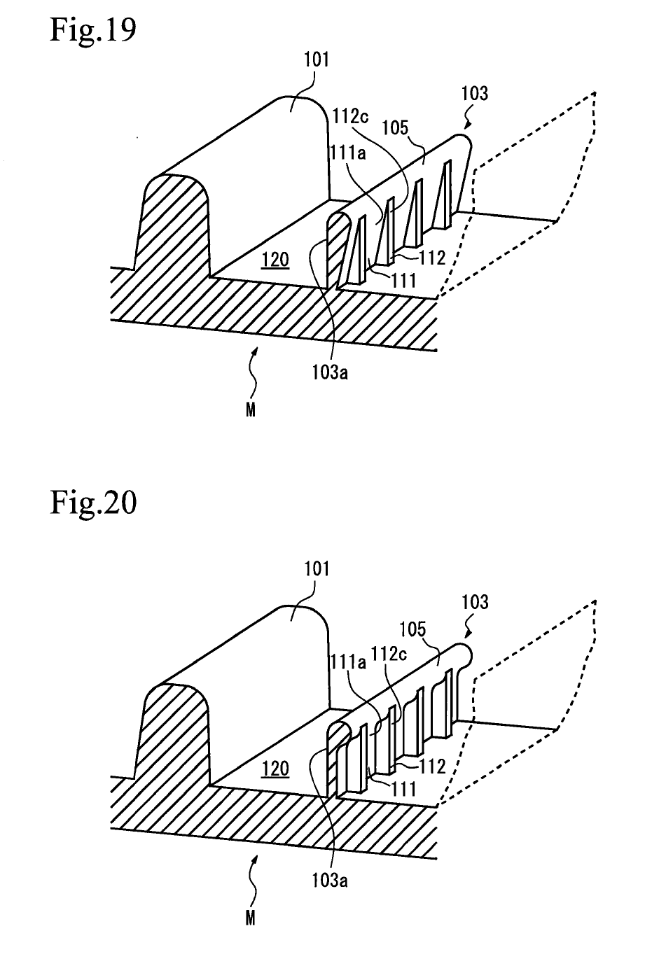

Next, the tire mold for molding the pneumatic tire of the present invention is hereby explained. FIGS. 19 to 22 show the mold for molding the shoulder portion as shown in FIGS. 3 to 4, FIGS. 5 to 6, FIGS. 7 to 8, and FIGS. 9 to 10, respectively. The main groove molding portion 101 that molds the main groove 1 that extends in the circumferential direction at the shoulder portion of the tread T and the fine groove molding portion 103 that molds the fine groove 3 that extends in the tire circumferential direction on the rib 2 formed by the main groove molding portion 101 are protruded from the tread molding surface 120 of the mold M. For information, the mold M may be a two-piece mold or a sector mold.

The tip portion 105 of the fine groove molding portion 103 is cross sectional arc shaped, which inhibits the generation of cracks at the groove bottom 5 of the fine groove 3 to be molded. The sidewall 103a on the inner side in the tire width direction of the fine groove molding portion 103 is substantially vertical to the tread molding surface 120, and the fine groove molding portion 103 is provided with the narrowed portions 111 and the wide portions 112 alternately in the circumferential direction. Since the sidewall 111a of the narrowed portion 111 enlarges its width as it goes toward the tip portion, the rigidity of the vicinity 4a of the narrowed portion 11 of the thin rib 4 to be formed is degraded and the grounding pressure at the shoulder portion is lowered as already mentioned, and therefore, the uneven wear at the shoulder portion is inhibited.

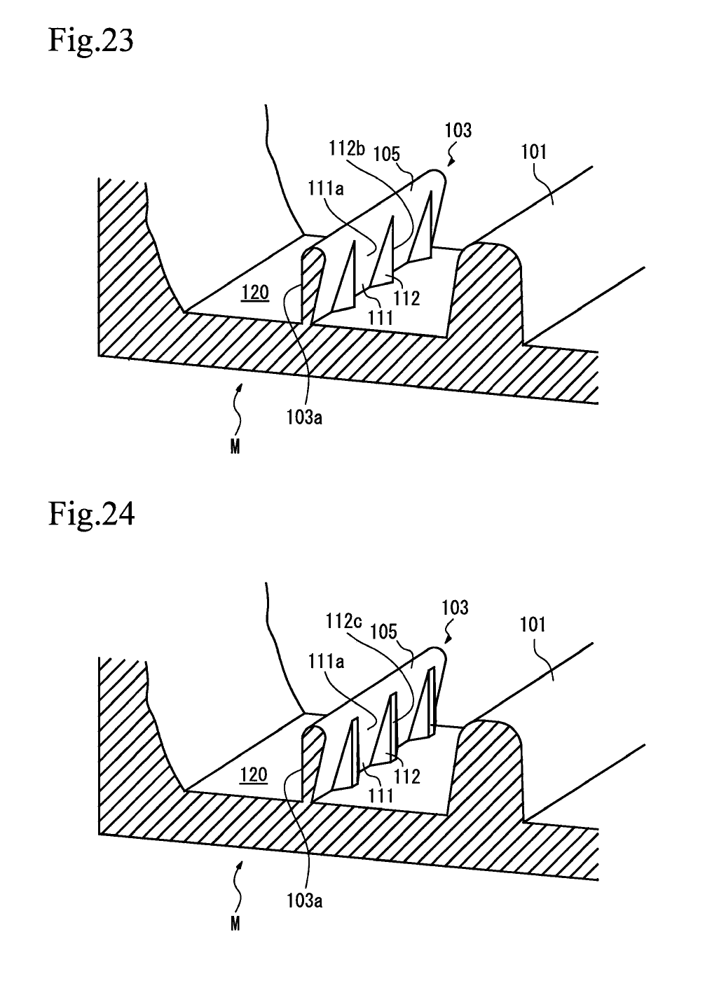

FIGS. 23 to 26 show the tire molds that mold the shoulder portion shown in FIGS. 11 to 12, FIGS. 13 to 14, FIGS. 15 to 16, and FIGS. 17 and 18. The main groove molding portion 101 molding the main groove 1 that extends in the circumferential direction at the shoulder portion of the tread T, and the fine groove molding portion 103 molding the fine groove 3 that extends in the circumferential direction to the rib 2 that is formed by the main groove molding portion 101 are protruded from the tread molding surface 120 of the mold M. For information, the mold M may be a two-piece mold or a sector mold.

The tip portion 105 of the fine groove molding portion 103 is cross sectional arc shaped, which inhibits the generation of cracks at the groove bottom 5 of the fine groove 3 to be molded. The sidewall 103a on the inner side in the tire width direction of the fine groove molding portion 103 is substantially vertical to the tread molding surface 120, and the fine groove molding portion 103 is provided with the narrowed portions 111 and the wide portions 112 alternately in the circumferential direction. Since the sidewall 111a of the narrowed portion 111 is inclined, the rigidity at the shoulder portion on the side of the fine groove 3 of the rib 2 to be formed, and together with the thin rib 4, the grounding pressure at the shoulder portion is lowered as already mentioned, and therefore, the uneven wear at the shoulder portion is inhibited.

The fine groove molding portions 103 are reinforced at the joining portion with the tread molding surface 120 by the wide portions 112 and the loss of the fine groove molding portions 103 likely to be generated when opening the mold M is inhibited. As a result, the durability of the mold M for molding tires is improved. For information, as already mentioned, from the view point of preventing cracks, it is preferable that the edge 112b and the tip portion 105 are joined so that the edge 112b of the wide portion 112 is on the tangent plane of the arc of the tip portion 105, and that the tangent plane of the arc of the tip portion 105 is joined tangentially to the sidewall 112c.

It is preferable that the width of the narrowed portion 111 of the fine groove molding portion 103 at the joining portion with the tread molding surface 120 (corresponding to W2 that is the width of the narrowed portion 11 of the fine groove 3) is 0.1 to 0.5 times as large as the maximum width of the tip portion 105 of the fine groove molding portion 103 (corresponding to W that is the maximum width of the groove bottom portion 5 of the fine groove 3) and that the maximum width of the wide portion at the joining portion with the tread molding surface (W1 that is the maximum width of the wide portion 12 of the fine groove 3) is 0.5 to 1.4 times as the maximum width of the tip portion 105 of the fine groove molding portion 103.

Further, from the viewpoint of reinforcing the fine groove molding portion 103, it is preferable that the number of the wide portion 112 is not less than 20 on the whole circumference of the fine groove molding portion 103, that the length of the wide portion 112 in the circumferential direction is 0.5 to 25.0 mm, and that the total sum of the length in the circumferential direction is 10 to 30% of the circumferential length of the fine groove molding portion 103.

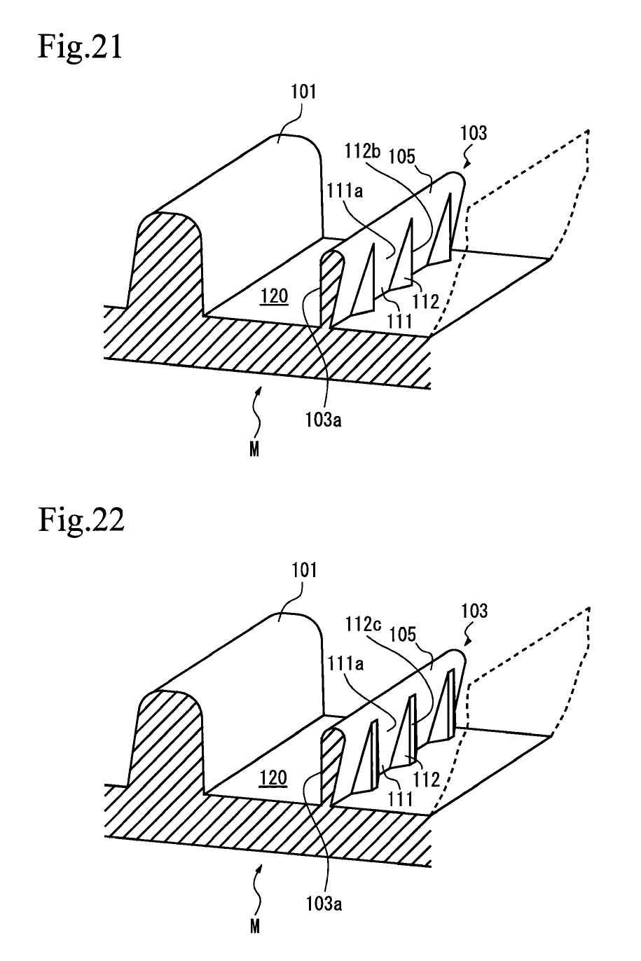

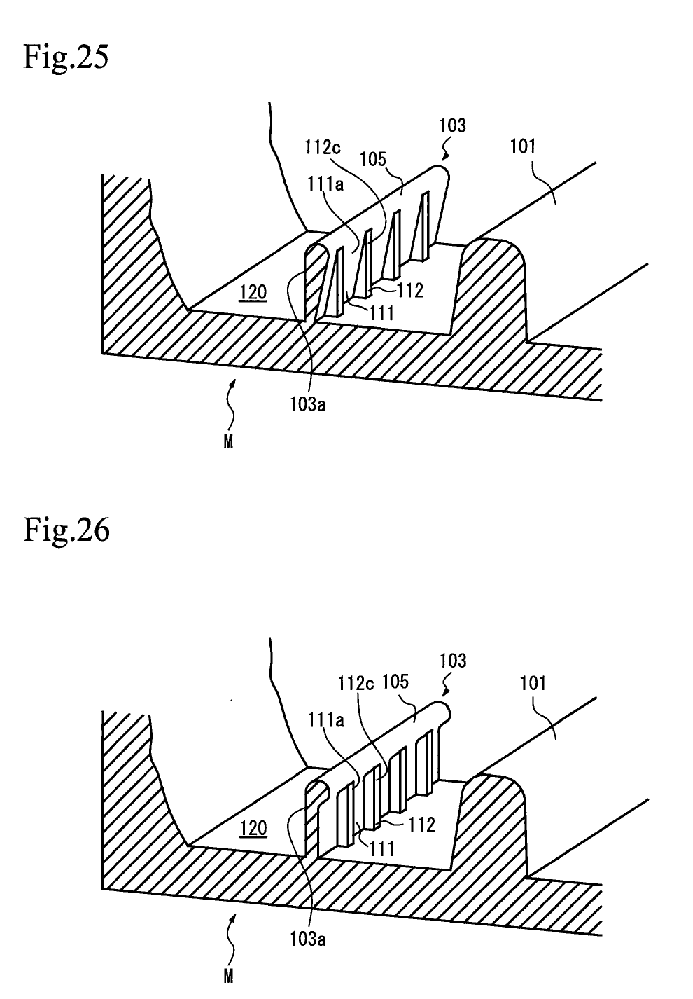

In producing the molding portion 103 of the fine groove shown in FIGS. 21 and 25, such methods are considered that a triangle plate that forms the wide portion 112 is cast integrally with the body of the fine groove molding portion 103, or that the triangle plate that forms the wide portion 112 is inserted, making the groove in the body of the fine groove molding portion 103. However, the strength at the joining portion of the wide portion 112 and the body of the fine groove molding portion 103 is degraded. Therefore, it is preferable that the wide portion 112 of the fine groove molding portion 103 is integrated with the body of the fine groove molding portion 103 that continues in the tire circumferential direction. For example, it is preferable that the fine groove molding portion 103 is produced by carving by NC processing, lost wax casting methods, and the like.

### EXAMPLE

As Examples, the pneumatic tires of the present invention and those of the Comparative Examples were test produced and the evaluation was made by installing the tires on front wheels of a tractor for towing a trailer (axle arrangement 2D). For information, the tire size was 295/75R 22.5 and air pressure was 720 kPa. The tires of the Examples 1 to 8 are for the tires provided with the shoulder portions as shown in FIGS. 3 to 4, FIGS. 5 to 6, FIGS. 7 to 8, FIGS. 9 to 10, FIGS. 11 to 12, FIGS. 13 to 14, FIGS. 15 to 16, and FIGS. 17 to 18 respectively, and were test produced by the tire molds shown by the FIGS. 19 to 26. The tires of the Comparative Examples 1 to 4 are for the tires provided with the shoulder portions without any wide portions. The size of each fine groove is shown in Tables 1 and 2 and in the Examples 4 and 8, the constant width portion of the fine groove and the groove bottom are joined by a curved surface that is convex to the inner side of the groove whose curvature radius is 4.5 mm.

The evaluation results are shown in Tables 1 and 2. Uneven wear resistance performance is the value of the width of the local wear of the edge of the side of the fine groove 3 of the rib 2 after driving 160,000 km represented by an index, letting the values of the Comparative Examples 1 and 4 represented as 100, and the larger value shows the narrower width of the local wear, showing that the effect of inhibiting the uneven wear is high. The presence of cracks at the groove bottoms are shown as a result by visually observing the tires after driving 160,000 km. The deflection at the molding portion of the fine groove is the result value measuring the deflection amount at the molding portion of the fine groove of the mold after the 1,000 tires related to the Examples and the Comparative Examples were vulcanized and molded, respectively. While the deflection was measured in the Comparative Examples 2 and 3, the deflection was not measured in the Examples. The Tables 1 and 2 show that the tires in the Examples could improve the durability of the tires as well as enhancing the inhibition effect of the uneven wear. In addition, the durability of the tire mold for molding could be improved.

TABLE 1

| | | | | | Comparative | |
|---|---|---|---|---|---|---|
| | Example | | | | Example | |
| | 1 | 2 | 3 | 4 | 1 | 2 |
| Maximum width of the wide | 3.5 | 4.0 | 2.5 | 3.5 | — | — |
| portion W1 (mm) | | | | | | |
| Length of the wide portion | 6.0 | 12.0 | 0.7 | 0.7 | — | — |
| L (mm) | | | | | | |
| Number of the wide portion | 160 | 80 | 500 | 500 | — | — |
| Ratio of the wide portion | 29.1 | 29.1 | 10.6 | 10.6 | — | — |
| with respect to the entire | | | | | | |
| circumference of fine | | | | | | |
| groove (%) | | | | | | |
| Width of the sidewall 12c | — | 8.0 | Same as L | Same as L | — | — |
| L1(mm) | | | | | | |
| Width of the narrow portion | 0.5 | 1.0 | 1.0 | 1.0 | 2.0 | 1.0 |
| W2 (mm) | | | | | | |
| Maximum width of the groove | 5.0 | 4.0 | 3.0 | 3.0 | 2.0 | 1.0 |
| bottom portion W (mm) | | | | | | |
| Depth of the fine groove | 15.0 | 15.0 | 15.0 | 15.0 | 15.0 | 15.0 |
| D (mm) | | | | | | |
| Depth of the equal width | — | — | — | 9.0 | — | — |
| portion of the fine groove | | | | | | |
| D1 (mm) | | | | | | |
| Uneven wear resistance | 150 | 150 | 140 | 140 | 100 | 120 |
| performance | | | | | | |
| Generation of cracks at the | No | No | No | No | Yes | Yes |
| groove bottom | | | | | | |
| Deflection at the molding | No | No | No | No | No | Yes |

Depth of the main groove: 14.5 mm

TABLE 2

| | | | | | Comparative | |
|---|---|---|---|---|---|---|
| | Example | | | | Example | |
| | 5 | 6 | 7 | 8 | 3 | 4 |
| Maximum width of the wide | 3.5 | 4.0 | 2.5 | 3.5 | — | — |
| portion W1 (mm) | | | | | | |
| Length of the wide portion | 6.0 | 12.0 | 0.7 | 0.7 | — | — |
| L (mm) | | | | | | |
| Number of the wide portion | 160 | 80 | 500 | 500 | — | — |
| Ratio of the wide portion | 29.1 | 29.1 | 10.6 | 10.6 | — | — |
| with respect to the entire | | | | | | |
| circumference of fine | | | | | | |
| groove (%) | | | | | | |
| Width of the sidewall 12c | — | 8.0 | Same as L | Same as L | — | — |
| L1(mm) | | | | | | |
| Width of the narrow portion | 0.5 | 1.0 | 1.0 | 1.0 | 1.0 | 3.0 |
| W2 (mm) | | | | | | |
| Maximum width of the groove | 5.0 | 4.0 | 3.0 | 3.0 | 1.0 | 3.0 |
| bottom portion W (mm) | | | | | | |
| Depth of the fine groove | 15.0 | 15.0 | 15.0 | 15.0 | 15.0 | 15.0 |
| D (mm) | | | | | | |
| Depth of the uniform width | — | — | — | 9.0 | — | — |
| portion of the fine groove | | | | | | |
| D1 (mm) | | | | | | |
| Uneven wear resistance | 140 | 130 | 130 | 140 | 130 | 100 |
| performance | | | | | | |
| Generation of cracks at the | No | No | No | No | Yes | No |
| groove bottom | | | | | | |
| Deflection at the molding | No | No | No | No | Yes | No |

Depth of the main groove: 14.5 mm

What is claimed is:

1. A pneumatic tire provided with a plurality of main grooves formed that extend in the tire circumferential direction on a tread, with ribs formed at least on a shoulder portion of the tread, with fine grooves formed that extend in the tire circumferential direction on the inner side in the tire width direction than the grounding end, wherein the fine grooves are provided with narrowed portions and wide portions alternately, the groove bottoms of the fine grooves are cross-sectional arc shaped, the sidewalls of the fine grooves on the inner side in the tire width direction are substantially vertical to the tread surfaces and are joined to the groove bottoms, and the sidewalls of the narrowed portion on the outer side in the tire width direction are joined to the groove bottoms so that the groove width gets larger as they go toward the groove bottoms.

2. The pneumatic tire as set forth in claim 1, wherein the width of the narrowed portions of the fine grooves at the tread opening portion are 0.1 to 0.5 times as the maximum width of the groove bottom portions of the fine grooves, and the maximum width of the wide portions at the tread opening portion are 0.5 to 1.4 times as the maximum width of the groove bottom portions of the fine grooves.

3. A pneumatic tire provided with a plurality of main grooves formed that extend in the tire circumferential direction on a tread, with ribs formed at least on a shoulder portion of the tread, with fine grooves formed that extend in the tire circumferential direction on the inner side in the tire width direction than the grounding end, wherein the fine grooves are provided with narrowed portions and wide portions alternately, the groove bottoms of the fine grooves are cross-sectional arc shaped, the sidewalls of the fine grooves on the outer side in the tire width direction are substantially vertical to the tread surfaces and are joined to the groove bottoms, and the sidewalls of the narrowed portion on the inner side in the tire width direction are joined to the groove bottoms so that the groove width gets larger as they go toward the groove bottoms.

4. The pneumatic tire as set forth in claim 3, wherein the width of the narrowed portions of the fine grooves at the tread opening portion are 0.1 to 0.5 times as the maximum width of the groove bottom portions of the fine grooves, and the maximum width of the wide portions at the tread opening portion are 0.5 to 1.4 times as the maximum width of the groove bottom portions of the fine grooves.

5. A tire mold for molding tires provided at least with main groove molding portions that protrude from the tread molding surface of the mold and that mold the main grooves extending in the tire circumferential direction of a tread and with fine groove molding portions that protrude from the tread molding surface and that mold the fine grooves extending in the tire circumferential direction on the rib formed by the main groove molding portions, wherein the fine groove molding portions are provided with narrowed portions and wide portions alternately in the circumferential direction at the joining portion of the tread molding surface, the tip portion of the fine groove molding portions is cross-sectional arc shaped, the sidewalls of the fine groove molding portions on the inner side in the tire width direction are substantially vertical to the tread molding surface and are joined to the tip portion, and the sidewalls of the narrowed portions on the outer side in the tire width direction are joined so that the width becomes larger as the sidewalls go toward the tip portion.

6. The tire mold for molding a tire as set forth in claim 5, wherein the width of the narrowed portion of the fine groove molding portion at the joining portion to the tread molding surface is 0.1 to 0.5 times as the maximum width of the tip portion of the fine groove molding portion, and the maximum width of the wide portion at the joining portion to the tread molding surface tread opening portion is 0.5 to 1.4 times as the maximum width of the tip portion of the fine groove molding portion.

7. A tire mold for molding tires provided at least with main groove molding portions that protrude from the tread molding surface of the mold and that mold the main grooves extending in the tire circumferential direction of a tread and with fine groove molding portions that protrude from the tread molding surface and that mold the fine grooves extending in the tire circumferential direction on the rib molded by the main groove molding portions, wherein the fine groove molding portions are provided with narrowed portions and wide portions alternately in the circumferential direction at the joining portion of the tread molding surface, the tip portion of the fine groove molding portions is cross-sectional arc shaped, the sidewalls of the fine groove molding portion on the outer side in the tire width direction are substantially vertical to the tread molding surface and are joined to the tip portion, and the sidewalls of the narrowed portions on the inner side in the tire width direction are joined so that the width becomes larger as the sidewalls go toward the tip portion.

8. The tire mold for molding a tire as set forth in claim 7, wherein the width of the narrowed portion of the fine groove molding portion at the joining portion to the tread molding surface is 0.1 to 0.5 times as the maximum width of the tip portion of the fine groove molding portion, and the maximum width of the wide portion at the joining portion to the tread molding surface tread opening portion is 0.5 to 1.4 times as the maximum width of the tip portion of the fine groove molding portion.
